(19) United States
(12) Patent Application Publication
(10) Pub. No.: US 2009/0292066 A1
(43) Pub. Date: Nov. 26, 2009

(54) PLASTISOLS BASED ON A METHYL METHACRYLATE COPOLYMER

(75) Inventors: Jan Hendrik Schattka, Hanau (DE); Gerd Loehden, Essen (DE); Winfried Belzner, Gruendau (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/373,531

(22) PCT Filed: Jun. 14, 2007
(86) PCT No.: PCT/EP2007/055861

§ 371 Date: Jan. 13, 2009

(30) Foreign Application Priority Data
Aug. 18, 2006 (DE) 10 2006 038 715.5

(51) Int. Cl. C08F 20/06; C08F 265/02; C09D 133/02

(52) U.S. Cl. 524/556; 526/317.1; 525/221

(57) ABSTRACT

The invention relates to plastisol systems with improved adhesion and with lower water absorption.

The invention relates to plastisol systems with improved adhesion and with lower water absorption.

The term plastisols generally means dispersions of finely divided polymer powders in plasticizers, which gel, i.e. harden, on heating to relatively high temperatures.

The resultant plastisols or organosols are used for a very wide variety of purposes, in particular as a sealing composition and sound-deadening composition, as underbody protection for motor vehicles, as anticorrosion coatings for metals, as coil coating, for impregnation and coating of substrates composed of textile materials and paper (also, for example, coatings on the backs of carpets), as floor coatings, as topcoats for floor coatings, for synthetic leather, or as cable insulation, etc.

An important field of application for plastisols is protection of sheet metal in the underbody bodywork of motor vehicles from stone chip. This application places particularly stringent requirements on the plastisol pastes and on the gelled films. An essential precondition is naturally high mechanical resistance to the abrasion caused by stone chip. Furthermore, an equally indispensable factor in the automobile industry is maximum useful life for plastisol pastes (storage stability).

No tendency towards water absorption is permissible in plastisol pastes, since water absorbed prior to gelling evaporates and leads to undesired blistering at the high temperatures during the gelling process.

Furthermore, the plastisol films have to have good adhesion to the substrate (mostly cathodically electrocoated sheet metal), this being not only an important precondition for abrasion properties but also moreover vital for corrosion protection.

In quantitative terms, easily the most frequently used polymer for preparation of plastisols is polyvinyl chloride (PVC).

Plastisols based on PVC exhibit good properties and are also relatively inexpensive, this being the main reason for their continued widespread use.

However, a number of problems arise with preparation and use of PVC plastisols. The actual preparation of PVC is itself somewhat problematic because the employees at the production sites are exposed to a health hazard by virtue of monomeric vinyl chloride.

Residues of monomeric vinyl chloride in the PVC could moreover also be hazardous to health during further processing or at the premises of the end user, although the residue contents are generally only in the ppb region.

A particularly difficult factor with the use of PVC plastisols is that PVC is sensitive both to heat and to light and is susceptible to elimination of hydrogen chloride. This is a serious problem particularly when the plastisol has to be heated to a relatively high temperature, since hydrogen chloride liberated under these conditions is corrosive and attacks metallic substrates. This is particularly important when relatively high stoving temperatures are used in order to shorten gel time, or when locally high temperatures occur, for example in spot welding.

The greatest problem arises with disposal of wastes comprising PVC: the compounds produced can sometimes comprise not only hydrogen chloride but also dioxins, which are highly toxic. PVC residues in conjunction with steel scrap can lead to an increase in the chloride content of molten steel, and this is likewise disadvantageous.

For the reasons mentioned, research and continuing development has been taking place for quite some time on alternatives to PVC plastisols which have their good processing properties and product properties but do not have the problems associated with the chlorine present.

By way of example one proposal is to replace vinyl chloride polymers at least to some extent by acrylic polymers (JP 60-258241, JP 61-185518, JP 61-207418). This approach has, however, merely mitigated the problems caused by the chlorine content, but has not solved them.

Various polymers—however usually not those exclusively prepared via emulsion polymerization—have been studied as chlorine-free binders; among these, for example, polystyrene copolymers (e.g. DE 4034725) and polyolefins (e.g. DE 10048055). However, the processability and/or the properties of the pastes or of the fully gelled films associated with these plastisols do not meet the requirements of users who have many years of experience with PVC plastisols.

However, polymethacrylates are a good alternative to PVC and have been described over many years for preparation of plastisols (e.g. DE 2543542, DE 3139090, DE 2722752, DE 2454235).

In recent years, plastisols based on polyalkyl methacrylates have been the subject matter of numerous patent applications containing improvements in the various properties demanded.

Various patent specifications mention the possibility of improving adhesion via incorporation of particular monomers.

These can by way of example be nitrogen-containing monomers, e.g. as described in DE 4030080.

DE 4130834 describes a plastisol system with improved adhesion to cataphoretic sheet metal, based on polyacrylic (meth)acrylates, where the binder comprises an anhydride, alongside monomers having an alkyl substituent of from 2 to 12 carbon atoms.

The improvement in adhesion via these monomers is generally not very marked, and large amounts of these monomers have to be used in order nevertheless to achieve a significant improvement in adhesion. This in turn results in an effect on other properties of the plastisol, too, examples being storage stability or ability to absorb plasticizer.

When changing monomer constitution, a dilemma often encountered is the need to accept impairment of a property in order to improve another property.

There have also been numerous attempts to achieve adhesion not through the binder itself but through various adhesion promoters which are added while formulating the plastisol.

The most important of these adhesion promoters are capped isocyanates, which are used mostly in conjunction with amine derivatives as hardeners (examples which may be mentioned being EP 214495, DE 3442646, DE 3913807).

The use of capped isocyanates has now become widespread and is without doubt making a considerable contribution to adhesion of plastisol films. Nevertheless, even with these adhesion promoters there remains a problem of inadequate adhesion. In addition, these additives are very expensive, and are therefore preferably used sparingly.

There are also a number of other proposed solutions, and mention may also be made here of the use of saccharides as adhesion promoters (DE 10130888).

Despite all efforts and approaches to a solution, achievement of adequate adhesion of plastisol films on various substrates remains a problem encountered in the development of plastisols for particular applications.

It was an object to provide poly(meth)acrylate plastisols with good adhesion. The measure used to achieve the improvement in adhesion should be capable of use in parallel with the methods previously used, in order to permit its immediate advantageous use without development of new formulations. Another object was to reduce the water absorption of the ungelled plastisol paste.

The object has been achieved using plastisols based on a binder, characterized in that

a) the binder is prepared via emulsion polymerization,
b) more than 50% by weight of the monomers of which the binder is composed have been selected from the group of acrylic acid, esters of acrylic acid, methacrylic acid and esters of methacrylic acid, and
c) the emulsifier used for preparation of the binder has at least one sulphate group.

Surprisingly, it has been found that the inventive plastisols based on a PMMA binder have excellent adhesion.

The excellent adhesion properties on metal surfaces and on cathodically electrocoated metal surfaces are of particular importance here. Improved adhesion in comparison with comparable binders of the prior art was moreover also found on other surfaces, such as polyolefins.

Good adhesion of the inventive plastisols on sheet metal or on metal surfaces permits a marked reduction in the amount of the adhesion promoter used. As a function of the application, it is indeed possible to omit additional adhesion promoters entirely.

Surprisingly, it has been found that the water absorption of these inventive plastisols has been markedly reduced. Conventional plastisols have a tendency to absorb water during storage and when they have been applied but not yet gelled. When the plastisols are later heated for the purpose of gelling, this water evaporates and leads to undesired blistering in the plastisol film.

“(Meth)acrylate” here means not only methacrylate, e.g. methyl methacrylate, ethyl methacrylate, etc., but also acrylate, e.g. methyl acrylate, ethyl acrylate, etc.

“Latices” here means dispersions of polymer particles in water, these being obtained via emulsion polymerization.

“Primary particles” here means the particles present after the emulsion polymerization process in the resultant dispersion (latex).

“Secondary particles” here means the particles obtained via drying of the dispersions (latices) obtained during the emulsion polymerization process.

Secondary particles very generally comprise—as a function of the drying process—many agglomerated primary particles.

The binders which are suitable for formulation of the inventive plastisols are prepared via emulsion polymerization, which can, if appropriate, be executed in a plurality of stages.

When emulsion polymerization is used, it is advantageously possible to operate by the emulsion- or monomer-feed process where some of the water, and also the entirety or proportions of the initiator and of the emulsifier are used as initial charge. The particle size can be controlled in these processes by way of example via the amount of emulsifier used as initial charge or via addition of a defined amount of previously manufactured particles (of what is known as a seed latex).

The initiator used can comprise not only the compounds conventional in emulsion polymerization, e.g. per-compounds, such as hydrogen peroxide, ammonium peroxodisulphate (APS), but also redox systems, such as sodium disulphite-APS-iron, or else water-soluble azo initiators. The amount of initiator is generally from 0.01 to 0.5% by weight, based on the polymer.

Within certain limits, the polymerization temperature depends on the initiators. For example, when APS is used it is advantageous to operate in the range from 60 to 90° C. When redox systems are used it is also possible to carry out polymerization at lower temperatures, for example at 30° C.

Operations can also be carried out by the batch polymerization process, as well as by the feed polymerization process. In batch polymerization, the entire amount or a proportion of the monomers is used as initial charge with all of the auxiliaries and the polymerization is initiated. The monomer-water ratio here has to be matched to the heat of reaction evolved. A method which can generally be used without difficulty to produce a 50% strength emulsion first emulsifies half of the monomers and of the auxiliaries in the entire amount of water and then initiates the polymerization at room temperature, and cools the batch after the reaction has taken place, and adds the remaining half of the monomers together with the auxiliaries.

In a typical embodiment of semicontinuous emulsion polymerization, water (and generally an emulsifier or a seed latex) is used as initial charge in the reactor and is heated to a particular initiation temperature, which is usually from 50 to 100° C. (preferably from 70 to 95° C.).

An initiator (or an initiator solution) is then added, and then a monomer emulsion (prepared from monomers, water and emulsifiers) or a monomer mixture (without water, but, if appropriate, with emulsifiers) is then fed.

As an alternative, it is also possible, prior to addition of initiator, to meter a certain relatively small amount of the monomer emulsion or of the monomer mixture into the reactor. After initiator addition, the metering of the remaining emulsion or monomer mixture is delayed until the initiation of the polymerization is discernible from the rising temperature in the reactor.

In the case of a multistage product, a further emulsion or monomer mixture is fed after addition of the first emulsion or monomer mixture, if appropriate after expiry of an intermediate reaction time and, if appropriate, after addition of further initiator. Further shells can be constructed around a core by repeating the last step.

Care is always to be taken to control the temperature (e.g. waterbath temperature) and to match the metering rates appropriately, in order to keep the process temperature in the selected temperature range. This is in turn dependent on the selection of the monomers and of the initiator, and can differ in the various stages, and is generally from 50 to 100° C.; preferably from 70 to 95° C.

These processes, and also numerous variations of the emulsion- or monomer-feed process or batch process have been described in detail in the relevant literature.

As is known to the person skilled in the art and familiar with emulsion polymerization technology, this technology can generate a variety of primary particle structures.

By way of example, polymerization of a monomer mixture A and subsequent polymerization of a monomer mixture B can produce primary particles in which the polymers produced in the second step envelop the polymer particles obtained in the first step. The term core-shell particles is also used in this instance.

The copolymers are generated from a core material and from a shell material in a manner known per se through a certain procedure during emulsion polymerization. In this process, the monomers forming the core material are polymerized in aqueous emulsion in the first stage of the process. When the monomers of the first stage have in essence been polymerized to completion, the monomer constituents of the shell material are added to the emulsion polymer under conditions which avoid formation of new particles. The result is that the polymer produced in the second stage is deposited in the manner of a shell around the core material.

It is moreover also possible to polymerize three or more different monomer mixtures A, B, C, etc. in succession. In this case, it is possible to arrive at structures in which layers of various polymers envelop a core in an onion-like structure. Another term then used is “multishell structure”.

Adjacent layers here are usefully composed of polymers with different monomer constitutions. Non-adjacent layers, however, can certainly also be composed of polymers with identical monomer constitution.

If operations are carried out by a feed process, the constitution of the monomer mixture added can also be changed continuously. This method can result in primary particles in which the monomer constitution of the polymers changes continuously from the centre of the particle to its surface. This type of structure is also called a gradient structure.

Finally, it is also possible to combine these structures, for example by having, between a core in the centre of the particle and an outer shell, a region in which the polymer constitution changes continuously from the polymer constitution of the core to that of the shell. Accordingly, the binder can be composed of primary particles which comprise regions of homogeneous monomer constitution and also regions with monomer constitution changing in the manner of a gradient.

Plastisols based on binders whose primary particles have one of these primary particle structures are preferred embodiments of this invention—alongside plastisols based on binders with simple, homogeneous primary particles composed only of polymers having a single monomer constitution.

The widespread use of emulsion polymerization has led to development of a large number of specific embodiments, some of which lead to specific structures. An example of one of these is the power-feed process, which can give specific gradient structures.

In particular applications, these specific structures can be advantageous for product properties, and one particular embodiment of the invention is therefore plastisols composed of binders whose primary particles have a structure which is permitted via one of the embodiments of the emulsion polymerization process—and specifically of the semicontinuous emulsion polymerization process.

The average size of the primary particles obtained by these processes is typically from 200 to 1200 nm, and this can be determined by laser scattering, for example. Preference is given to primary particle sizes of from 500 to 1000 nm; particular preference is given to primary particle sizes of from 600 to 800 nm.

The binders suitable for preparation of the inventive plastisols preferably contain from 40 to 98% by weight of methyl methacrylate, preferably from 50 to 88% by weight of methyl methacrylate; particular preference is given to from 60 to 78% by weight of methyl methacrylate.

The binders suitable for preparation of the inventive plastisols moreover preferably contain from 0 to 60% by weight, and more preferably from 15 to 50% by weight, of other alkyl esters of methacrylic acid, e.g. ethyl methacrylate, n-propyl methacrylate, isopropyl methacrylate, n-butyl methacrylate, isobutyl methacrylate, tert-butyl methacrylate, pentyl methacrylate, hexyl methacrylate, cyclohexyl methacrylate, or others, and also mixtures thereof. Particular preference is given to from 25 to 40% by weight.

The binders suitable for preparation of the inventive plastisols can moreover preferably contain from 0 to 30% by weight, preferably up to 20% by weight, of alkyl esters of acrylic acid; examples are methyl acrylate, ethyl acrylate, butyl acrylate and others, and also mixtures thereof. Particular preference is given to from 0 to 10% by weight.

The binders suitable for preparation of the inventive plastisols can moreover preferably contain from 0 to 10% by weight of acid-containing monomers and/or monomers having an amide group. Examples of these monomers are acrylic acid, methacrylic acid, itaconic acid, maleic acid, fumaric acid, 2-propene-1-sulphonic acid, styrenesulphonic acid, acrylamidododecanesulphonic acid, acrylamide, methacrylamide, and others, and also mixtures thereof. Particular preference is given to from 0.1 to 5% by weight, and especially preferably from 0.3 to 3% by weight, of acid-containing monomers and/or monomers having an amide group. These acids and/or amides are preferably capable of free-radical copolymerization with the monomers mentioned under a), b) and c).

The binders suitable for preparation of the inventive plastisols moreover contain from 0 to 30% by weight, preferably from 0.5 to 15% by weight of other monomers capable of copolymerization with the abovementioned monomers. Examples of these monomers are styrene, ethene, propene, n-butene, isobutene, n-pentene, isopentene, n-hexene, divinylbenzene, ethylene glycol dimethacrylate, hydroxyethyl methacrylate, 9-vinylcarbazole, vinylimidazole, 3-vinylcarbazole, 4-vinylcarbazole, vinyloxolane, vinylfuran, vinylthiophene, vinylthiolane, glycidyl methacrylate, 2-ethoxyethyl methacrylate, tetrahydrofurfuryl methacrylate, and others, and also mixtures of these. Particular preference is given to from 1 to 8% by weight of these monomers.

The % by weight data given are based on the total weight of the monomers, where a), b), c), d) and e) together give 100% by weight.

The percentages by weight mentioned are in each case based on the entirety of the primary particles of the binder. In the case of primary particles having a multistage structure, the constitutions of the individual shells and of the core can certainly deviate from the limits mentioned; however, the limits given, based on the entire particle, represent a preferred embodiment of the invention.

The inventive preparation of the binders via emulsion polymerization requires the use of a surfactant; according to the invention, this surfactant contains at least one sulphate group.

The emulsifier used for preparation of the binder is preferably composed of (a) a sulphate group, (b) a branched or unbranched or cyclic alkyl group having more than 8 carbon atoms, and (c) if appropriate, ethylene glycol unit, diethylene glycol unit, triethylene glycol unit, or a higher-molecular-weight polyethylene glycol unit.

In a preferred embodiment of the invention, alkyl sulphates are used.

Emulsifiers that can be used here are firstly those which are composed chemically of only one type of molecule, an example being “sodium n-hexadecyl sulphate”. In this case, the alkyl radical is composed only of an unbranched hexadecyl radical.

Other examples are sodium n-octyl sulphate, sodium n-decyl sulphate, sodium n-dodecyl sulphate, sodium n-hexadecyl sulphate, sodium 2-ethylhexyl sulphate, sodium n-octadecyl sulphate.

However, emulsifiers with mixtures of various alkyl radicals are frequently encountered by virtue of the raw materials used in the preparation of surfactants.

An example that may be mentioned is “C16-C18 sulphates”; this surfactant is composed of various alkyl sulphates having from 16 to 18 carbon atoms, their constitution depending on the raw material used.

These surfactants can also—depending on purity—have “contamination” by shorter- or longer-chain alkyl sulphates.

Preference is given to alkyl radicals having more than 8 carbon atoms; particular preference is given to emulsifiers whose alkyl radicals are mainly C12-C14-alkyl radicals.

In another preferred embodiment of the invention, the surfactants used are those which have one or more ethylene oxide (—CH2-CH2-O—) units between the alkyl group and the sulphate group. These are also termed fatty alcohol polyethylene glycol ether sulphates. Examples of these are

Preference is given to from 2 to 8 ethylene oxide units.

Other examples of surfactants suitable for preparation of binders which are suitable for preparation of the inventive plastisols are alkylphenol ether sulphates.

Emulsion polymerization gives latices which comprise the binders as dispersion in water.

The binders can be obtained in solid form in a conventional manner by freeze drying, precipitation or preferably spray drying.

The dispersions can be spray-dried in a known manner. In industry, equipment known as spray towers is used, and the dispersion sprayed into these usually flows downwardly through these cocurrently with hot air. The dispersion is sprayed through one or more nozzles or preferably atomized by means of a perforated plate rotating at high speed. The temperature of the incoming hot air is from 100 to 250° C., preferably from 150 to 250° C. The exit temperature of the air is decisive for the properties of the spray-dried emulsion polymer, and this means the temperature at which the dried powder grains are separated from the stream of air at the base of the spray tower or in a cyclone separator. The intention is to keep this temperature below the temperature at which the emulsion polymer would sinter or melt. An exit temperature of from 50 to 95° C. has good suitability in many cases; exit temperatures of from 70 to 90° C. are preferred.

Given a constant stream of air, the exit temperature can be controlled by varying the amount of dispersion continuously sprayed into the system per unit of time.

Secondary particles are mostly formed here, these being composed of agglomerated primary particles. It can sometimes be advantageous to fuse the individual primary particles with one another during drying to give larger units (partial vitrification).

A value that can be adopted as guideline for the average grain sizes of the agglomerated units (measured by way of example by the laser scattering method) is from 5 to 250 μm. Secondary particle sizes of from 20 to 120 μm are preferred; secondary particle sizes of from 40 to 80 μm are particularly preferred.

The quantitative proportions in plastisol pastes can vary widely. In typical formulations, the proportions of the plasticizers present are from 50 to 300 parts by weight for 100 parts by weight of the binder. For appropriate matching to rheological requirements—in particular during the processing of the plastisols—it is also possible to use solvents (e.g. hydrocarbons) as diluents.

Examples of plasticizers used are the following substances:
esters of phthalic acid, e.g. diundecyl phthalate, diisodecyl phthalate, diisononyl phthalate, dioctyl phthalate, diethylhexyl phthalate, di-C7-C11-n-alkyl phthalate, dibutyl phthalate, diisobutyl phthalate, dicyclohexyl phthalate, dimethyl phthalate, diethyl phthalate, benzyl octyl phthalate, butyl benzyl phthalate, dibenzyl phthalate and dihexyldicapryl phthalate,
hydroxycarboxylic esters, e.g. esters of citric acid (e.g. tributyl O-acetylcitrate, triethyl O-acetylcitrate), esters of tartaric acid or esters of lactic acid,
aliphatic dicarboxylic esters, e.g. esters of adipic acid (e.g. dioctyl adipate, diisodecyl adipate), esters of sebacic acid (e.g. dibutyl sebacate, dioctyl sebacate, bis(2-ethylhexyl) sebacate) or esters of azelaic acid,
esters of trimellitic acid, e.g. tris(2-ethylhexyl) trimellitate, esters of benzoic acid, e.g. benzyl benzoate,
esters of phosphoric acid, e.g. tricresyl phosphate, triphenyl phosphate, diphenyl cresyl phosphate, diphenyl octyl phosphate, tris(2-ethylhexyl) phosphate, tris(2-butoxyethyl) phosphate,
alkylsulphonic esters of phenol or of cresol, dibenzyltoluene, diphenyl ether.

The plasticizers mentioned and other plasticizers are used individually or in the form of a mixture.

Preference is given to use of phthalates, adipates, phosphates or citrates; particular preference is given here to phthalates.

The plastisols also usually comprise amounts of from 0 to 300 parts by weight of inorganic fillers. Examples which may be mentioned are calcium carbonate (chalk), titanium dioxide, calcium oxide, precipitated and coated chalks, these being additives having rheological action, and also, if appropriate, agents with thixotropic effect, e.g. fumed silica.

Amounts of from 40 to 120 parts, by weight of adhesion promoters are moreover often added to the plastisol; examples of those used are polyaminoamides or capped isocyanates.

EP 1371674 describes, by way of example, self-crosslinking capped isocyanates as effective adhesion promoters in the application in the sector of poly(meth)acrylate plastisols.

The plastisols can also comprise, as necessary for the application, other constituents (auxiliaries) conventional in plastisols, e.g. wetting agents, stabilizers, flow agents, pigments, blowing agents.

Calcium stearate as flow agent may be mentioned by way of example.

In principle, the components for the inventive plastisols can be mixed by various types of mixer. However, as has been found with PVC plastisols and poly(meth)acrylate plastisols, preference is given to low-speed planetary mixers, high-speed mixers and the corresponding dissolvers, horizontal turbo mixers and three-roll systems; the choice here is affected by the viscosity of the plastisols produced.

The layer thicknesses at which the plastisol composition can typically be gelled within a period of less than 30 minutes are from 0.05 to 5 mm at temperatures of from 100 to 220° C. (preferably from 120 to 180° C.).

The method of application for the coating of metal parts is nowadays preferably a spray process, e.g. a paste-spray process. The plastisol here is usually processed by way of airless spray guns using high pressures (from about 300 to 400 bar).

The usual procedure in the particularly important application sector of automobile production/underbody protection is that the plastisol is applied after electrodeposition coating of the bodywork and drying. Heat-curing usually takes place in an oven (e.g. convection oven) using conventional residence times—depending on the temperature—in the range from 10 to 30 minutes and temperatures of from 100 to 200° C., preferably from 120 to 160° C.

There are many descriptions (cf. DE-A 27 51 498, DE-A 27 53 861, DE-A 27 32 736, DE-A 27 33 188, DE-A 28 33 786) of cataphoretic coating of metallic substrates.

The inventive plastisols can be used for seam-covering. Furthermore, these plastisols can be used for protection of the underbody of automobiles (e.g. with respect to stone chip). There are also application sectors in acoustic sound-deadening, e.g. in automobile construction and in household devices (e.g. refrigerators and washing machines).

The examples given below are given for better illustration of the present invention but are not intended to restrict the invention to the features disclosed herein.

### EXAMPLES

### Inventive Example 1

1100 g of water are used as initial charge under nitrogen in a 5 litre reactor whose temperature can be controlled by means of a waterbath and which has stirrer, reflux condenser, thermometer and metering pump. The system is preheated to from 74° C. to 76° C., with stirring.

For initiation, 30 ml of a 5% strength aqueous solution of sodium peroxodisulphate and 30 ml of a 5% strength aqueous solution of sodium hydrogen sulphite are added.

A monomer emulsion, composed of 500 g of methyl methacrylate, 250 g of isobutyl methacrylate and 250 g of n-butyl methacrylate, and also 8 g of sodium dodecyl sulphate and 450 ml of deionized water, are then added dropwise in the course of one hour.

After the feed has ended, the mixture is stirred for 30 min and then a further 15 ml of a 5% strength aqueous solution of sodium peroxodisulphate and 15 ml of a 5% strength aqueous solution of sodium hydrogen sulphite are added.

A second monomer emulsion composed of 700 g of methyl methacrylate, 130 g of isobutyl methacrylate, 130 g of n-butyl methacrylate, 40 g of methacrylamide and 8 g of sodium dodecyl sulphate and 450 ml of deionized water is fed within one hour. Waterbath cooling is used to avoid any rise of the reaction temperature above 80° C.

After addition of the emulsion, the temperature is held at from 75° C. to 80° C. during a post-reaction time of 30 min, before the resultant dispersion is cooled to room temperature.

The polymer dispersion is converted to a powder in a drying tower with centrifugal atomizer. The tower exit temperature here is 80° C.; the rotation rate of the atomizer plate is 20 000 rpm.

### Comparative Example 1

For preparation of Comparative Example 1, the procedure was in all respects as in preparation of Inventive Example 1, with one exception. The emulsifier sodium dodecyl sulphate was in each case merely replaced by the identical amount of the emulsifier bis-2-ethylhexyl sulphosuccinate (sodium salt).

### Preparation of Plastisols for Assessment of Water Absorption and Adhesion

The plastisol paste for assessment of water absorption is prepared in a dissolver by a method based on that specified in DIN 11468 for polyvinyl chloride pastes.

The following components were used:
100 parts by weight of binder (core-shell polymer)
100 parts by weight of plasticizer (diisononyl phthalate)
25 parts by weight of capped isocyanate (e.g. “Desmocap 11”)
2 parts by weight of curing agent for isocyanates (e.g. “Laromin C 260”)
100 parts by weight of precipitated calcium carbonate (e.g. “Mikhart MU 12T”)
10 parts by weight of calcium oxide (e.g. “Omyalite 90”)
15 parts by weight of solvent (e.g. “Isopar H”)

### Assessment of Water Absorption

The plastisol paste—prepared as described above—was applied with a doctor to an area of 80 mm×80 mm at 2 mm thickness to a thin metal plate (thickness about 1 mm) and pregelled first for 15 minutes at 110° C. and then for 30 minutes at 140° C. in an oven.

The resultant coated metal plate was stored at 30° C. for 10 days in an atmosphere with 80% relative humidity. The plastisol was then gelled to completion during 30 minutes in an oven at 140° C.

Water absorption was assessed qualitatively on the basis of visual inspection of the film surface; high water absorption was apparent in unevenness and blisters, whereas good specimens have a smooth, defect-free surface.

The binder according to Inventive Example 1 exhibited significantly fewer blisters in this test than the binder prepared according to Comparative Example 1. Counting of the blisters on a particular area A gave from 30% to 40% fewer blisters in the plastisol composed of the binder according to Inventive Example 1; the blisters were moreover smaller.

### Assessment of Adhesion of Gelled Plastisol Film

The plastisol paste—prepared as described above—was applied in the form of a wedge by an adjustable-gap doctor (gap width from 0 to 3.0 mm) to cathodically electrocoated sheet metal. Hardening took 20 minutes at 160° C.

An incision is made in the fully gelled plastisol film (wedge) parallel to the layer-thickness gradient, using a sharp blade, at intervals of 1 cm, extending as far as the cathodically electrocoated substrate.

The resultant plastisol strips of width 1 cm are peeled from the substrate—beginning at the thin end.

The thickness of the film at the site of film break-away is taken as a measure of adhesion, low film thickness here corresponding to good adhesion.

The film thickness at the break-away point is determined using a layer-thickness measurement device.

The break-away thickness determined in the above test was 210 μm for the plastisol prepared using Comparative Example 1; the plastisol prepared using Inventive Example 1 had markedly better adhesion: the break-away thickness measured was 60 μm.

1. A plastisol based on a binder, wherein
a) the binder is prepared via emulsion polymerization,
b) more than 50% by weight of the monomers of which the binder is composed have been selected from the group of acrylic acid, esters of acrylic acid, methacrylic acid and esters of methacrylic acid, and
c) the emulsifier used for preparation of the binder has at least one sulphate group.

2. The plastisol based on a binder according to claim 1, wherein the binder is composed of primary particles which have a core-shell structure in which the monomer constitution of core and shell are different.

3. The plastisol based on a binder according to claim 1, wherein the binder is composed of primary particles which have a multishell structure, where a plurality of shells, whose monomer constitution can differ, have been arranged concentrically around a centrally located core.

4. The plastisol based on a binder according to claim 1, wherein the binder is composed of primary particles which have a gradient structure, so that the monomer constitution of the particle changes from the centre to the surface of the particle.

5. The plastisol based on a binder according to claim 1, wherein the binder is composed of primary particles which comprise regions of homogeneous monomer constitution and also regions with monomer constitution changing in the manner of a gradient.

6. The plastisol based on a binder according to claim 1, wherein the binder is composed of primary particles which have a structure which is permitted via one of the embodiments of a semicontinuous emulsion polymerization process.

7. The plastisol based on a binder according to claim 2, wherein the average size of the primary particles is from 200 to 1200 nm.

8. The plastisol based on a binder according to claim 1, wherein the binder contains, based on the total weight of the monomers,
a) from 40 to 98% by weight of the methyl ester of methacrylic acid,
b) from 0 to 60% by weight of other alkyl esters of methacrylic acid,
c) from 0 to 30% by weight of alkyl esters of acrylic acid,
d) from 0 to 10% by weight of an acid and/or of an amide—which is capable of free-radical copolymerization with the monomers mentioned under a), b) and c), and
e) from 0 to 30% by weight of other monomers capable of free-radical copolymerization with the monomers mentioned under a), b) and c), where a), b), c), d) and e) together give 100% by weight.

9. The plastisol based on a binder according to claim 1, wherein the emulsifier used for preparation of the binder is composed of
a) a sulphate group,
b) a branched or unbranched or cyclic alkyl group having more than 8 carbon atoms, and
c) optionally, an ethylene glycol unit, a diethylene glycol unit, a triethylene glycol unit, or a higher-molecular-weight polyethylene glycol unit.

10. The plastisol based on a binder according to claim 1, wherein the emulsifier used for preparation of the binder is an alkyl sulphate.

11. The plastisol based on a binder according to claim 1, wherein the emulsifier used for preparation of the binder is an alkyl sulphate where the alkyl radicals mainly contain from 12 to 14 carbon atoms.

12. The plastisol based on a binder according to claim 1, wherein the binder is a powder whose average particle size is from 5 μm to 250 μm.

13. A process for preparation of plastisols based on a binder according to claim 1, wherein
a) the binder is prepared via emulsion polymerization, which is, optionally, executed in a plurality of stages,
b) the binder is converted, via drying of the resultant dispersion, to a powder, with which
c) at least one plasticizer and, optionally, adhesion promoters and/or fillers and further constituents conventional in plastisols are then admixed.

14. The Process for preparation of plastisols based on a binder according to claim 12, wherein, for preparation of the binder, an initiator solution is used as an initial charge and a monomer emulsion is fed, to which, optionally, further monomer emulsions are fed at temperatures of from 50° C. to 100° C.

15. The process for preparation of plastisols according to claim 12, wherein various monomer emulsions are fed.

16. The process for preparation of plastisols according to claim 12, wherein the feed of the second and of every further monomer emulsion takes place at from 70 to 95° C.

17. The process for preparation of plastisols according to claim 12, wherein from 50 to 300 parts by weight of plasticizer, from 40 to 120 parts by weight of adhesion promoter and/or from 0 to 300 parts by weight of fillers are admixed with 100 parts by weight of binder.

18. The process for preparation of plastisols according to claim 12, wherein the dispersions are dried by means of spray drying.

19. The plastisol according to claim 1 for coating of metallic surfaces.

20. A coated metallic surface, wherein the coating has taken place with a plastisol according to claim 1, optionally after prior electrodeposition coating.

21. An underbody protection comprising a plastisol according to claim 1.

22. A seam-covering comprising a plastisol according to claim 1.

23. A method for damping sheet metal vibrations comprising applying a plastisol according to claim 1.

24. A coating for polyolefins comprising a plastisol according to claim 1.
